(19) United States
(12) Patent Application Publication
(10) Pub. No.: US 2014/0218905 A1
(43) Pub. Date: Aug. 7, 2014

(54) Light-Emitting Module, Straight Tube Lamp and Luminaire

(71) Applicant: TOSHIBA LIGHTING & TECHNOLOGY CORPORATION, Yokosuka-shi (JP)

(72) Inventors: Tetsuya Ono, Yokosuka-shi (JP); Masahiko Kamata, Yokosuka-shi (JP)

(73) Assignee: TOSHIBA LIGHTING & TECHNOLOGY CORPORATION, Yokosuka-shi (JP)

(21) Appl. No.: 14/032,501

(22) Filed: Sep. 20, 2013

(30) Foreign Application Priority Data
Feb. 7, 2013 (JP) 2013-021867

(51) Int. Cl. F21K 99/00; F21V 21/00

(52) U.S. Cl. CPC F21K 9/10; F21V 21/00
USPC 362/217.01; 313/1

(57) ABSTRACT

According to one embodiment, a light-emitting module includes a rectangular substrate, at least two light-emitting circuits and inter-module connection part. The light-emitting circuit connects plural light-emitting elements in a longitudinal direction of the substrate. The inter-module connection parts include respective pairs of electrodes connected with the respective light-emitting circuits on an end of the substrate in the longitudinal direction. The respective pairs of electrodes are arranged to be closer to side parts of the substrate in a short direction thereof than an arrangement area of the light-emitting elements and are arranged side by side in the longitudinal direction of the substrate.

### INCORPORATION BY REFERENCE

The present invention claims priority under 35 U.S.C. §119 to Japanese Patent Application No. 2013-021867 filed on Feb. 7, 2013. The content of the application is incorporated herein by reference in their entirety.

### FIELD

Embodiments described herein relate generally to a light-emitting module including an inter-module connection part, a straight tube lamp using the light-emitting module, and a luminaire using the straight tube lamp.

### BACKGROUND

Hitherto, there is a straight tube lamp using a light-emitting element such as an LED element. In this straight tube lamp, plural light-emitting modules linearly arranged side by side are contained in a straight tube cover, and caps are attached to both ends of the cover.

The light-emitting module includes a longitudinal substrate. Plural light-emitting elements are arranged in the longitudinal direction of the substrate, and one light-emitting circuit to connect these plural light-emitting elements in series is formed. An inter-module connection part including a pair of electrodes to which the light-emitting circuit is connected is formed at an end of the substrate. When the light-emitting modules are arranged side by side, a connection member connects the electrodes of the light-emitting modules arranged side by side.

In the light-emitting module of the related art, the one light-emitting circuit is mounted on the substrate. Accordingly, the inter-module connection part arranged at the end of the substrate includes only two electrodes, and it is not considered that more than two electrodes are arranged and the light-emitting modules are connected.

When more than two electrodes are arranged at the end of the substrate and the light-emitting modules are connected, many electrodes are arranged along the end of the substrate. When electrodes must be arranged also in the arrangement area of the plural light-emitting elements in the longitudinal direction of the substrate, the arrangement pitch of the light-emitting elements between the light-emitting modules is increased. Accordingly, a dark part occurs between the light-emitting modules, and a uniform light-emitting distribution can not be obtained between the light-emitting modules.

### BRIEF DESCRIPTION OF THE DRAWINGS

FIG. 1 is a front view of a light-emitting module of a first embodiment.

FIG. 2 is a wiring view of a straight tube lamp using the light-emitting module.

FIG. 3 is a perspective view of the straight tube lamp.

FIG. 4 is a luminaire using the straight tube lamp.

FIG. 5 is a structural view of a lighting system using the luminaire.

FIG. 6 is a wiring view of a straight tube lamp using a light-emitting module of a second embodiment.

FIG. 7 is a perspective view of the straight tube lamp.

FIG. 8 is a front view of a light-emitting module of a third embodiment.

### DETAILED DESCRIPTION

In general, according to one embodiment, a light-emitting module includes a rectangular substrate, at least two light-emitting circuits and inter-module connection parts. The light-emitting circuit connects plural light-emitting elements in a longitudinal direction of the substrate. The inter-module connection parts include respective pairs of electrodes connected with the respective light-emitting circuits at an end of the substrate in the longitudinal direction. The respective pairs of electrodes are arranged to be closer to side parts of the substrate in a short direction thereof than an arrangement area of the light-emitting elements and are arranged side by side in the longitudinal direction of the substrate.

Even when the light-emitting module includes at least the two light-emitting circuits, the inter-module connection part is formed such that the respective pairs of electrodes connected with the respective light-emitting circuits are arranged to be closer to the side parts of the substrate in the short direction thereof than the arrangement area of the light-emitting elements and are arranged side by side in the longitudinal direction of the substrate. Accordingly, at least the two light-emitting circuits can be connected between the light-emitting modules by using the inter-module connection part. Further, the arrangement of the light-emitting elements toward an end side of the substrate is not restricted by the electrodes, and a uniform light-emitting distribution can be obtained between the light-emitting modules.

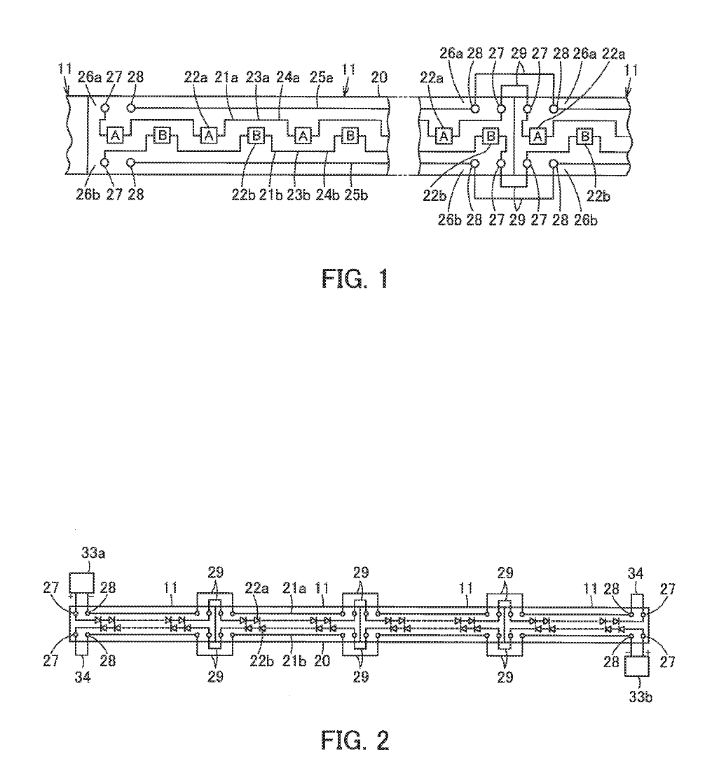

Hereinafter, a first embodiment will be described with reference to FIG. 1 to FIG. 5.

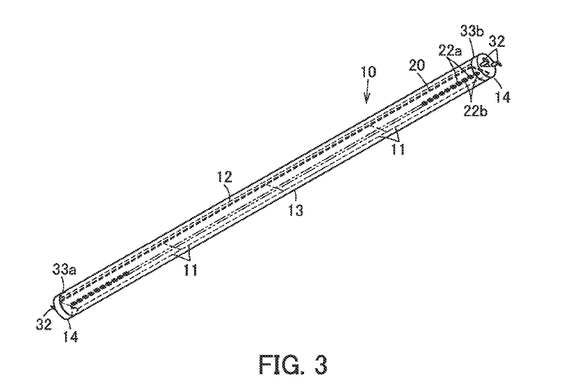

FIG. 3 shows a straight tube lamp 10. The straight tube lamp 10 includes plural light-emitting modules 11, a longitudinal support body 12 on which the plural light-emitting modules 11 are linearly arranged and are supported, a straight tube cover 13 to contain the plural light-emitting modules 11 and the support body 12, and caps 14 attached to both ends of the cover 13.

As shown in FIG. 1, the light-emitting module 11 includes a substrate 20 formed into a rectangle and made of a metal, for example, aluminum or a material such as a ceramic or a resin. A first light-emitting circuit 21a and a second light-emitting element 21b as light-emitting circuits are formed on a mount surface as one main surface of the substrate 20 and are insulated from each other. The first light-emitting circuit 21a and the second light-emitting circuit 21b are constructed such that for example, different color lights are emitted in total, and for example, lights of color temperatures different from each other are emitted.

The first light-emitting circuit 21a includes plural first light-emitting elements 22a (see “A” of FIG. 1) which are light-emitting elements to emit light of a first color temperature and are mounted on the mount surface of the substrate 20 at a constant pitch in the longitudinal direction of the substrate 20, and a first wiring part 23a which is a wiring pattern formed on the mount surface of the substrate 20 and connects the plural light-emitting elements 22a in series. The first wiring part 23a includes an inter-element wiring part 24a to connect the plural first light-emitting elements 22a in series from one end side of the substrate 20 to the other end side, and a return wiring part 25a wired from the other end side of the substrate 20 to the one end side.

The second light-emitting circuit 21b includes plural second light-emitting elements 22b (see “B” of FIG. 1) which are light-emitting elements to emit light of a second color temperature different from the first color temperature and are mounted on the mount surface of the substrate 20 at a constant pitch in the longitudinal direction of the substrate 20, and a second wiring part 23b which is a wiring pattern formed on the mount surface of the substrate 20 and connects the plural second light-emitting elements 22b in series. The second wiring part 23b includes an inter-element wiring part 24b to connect the second light-emitting elements 22b in series from the one end side of the substrate 20 to the other end side, and a return wiring part 25b wired from the other end side of the substrate 20 to the one end side. Incidentally, for example, the second color temperature is 6500 K, and the first color temperature is 3000 K. The second color temperature may be higher than the first color temperature, or the second color temperature may be lower than the first color temperature.

The first light-emitting elements 22a and the second light-emitting elements 22b are arranged at the center in the short direction of the substrate 20, and the first light-emitting elements 22a and the second light-emitting elements 22b are linearly alternately arranged one by one at a constant inter-element pitch in the longitudinal direction of the substrate 20. The first wiring part 23a is arranged on one side of the substrate 20 in the short direction, and the second wiring part 23b is arranged on the other side. By this structure, the insulation state of the first light-emitting circuit 21a and the second light-emitting circuit 21b is ensured. Besides, a distance between each of the light-emitting elements 22a and 22b positioned at both ends of the substrate 20 and an end of the substrate 20 is ½ of the inter-element pitch.

The light-emitting elements 22a and 22b include, for example, LED elements or EL elements. In the case of the LED elements, for example, an SMD (Surface Mount Device) package of surface mount type or the like is used.

A first inter-module connection part 26a and a second inter-module connection part 26b are formed on the mount surface of the substrate 20. The first inter-module connection part 26a and the second inter-module connection part 26b are inter-module connection parts for electrically connecting the first light-emitting circuits 21a of the adjacent light-emitting modules 11 and the second light-emitting circuits 21b thereof when the plural light-emitting modules 11 are linearly arranged in the longitudinal direction and are connected. The inter-module connection parts 26a and 26b are respectively formed at both ends of the substrate 20 in the longitudinal direction and at both sides of the substrate 20 in the short direction, which are separate from a mount area (center area of the substrate 20 in the short direction) where the plural light-emitting elements 22a and 22b are linearly arranged in the longitudinal direction of the substrate 20. The inter-module connection parts 26a and 26b respectively include electrodes 27 to which ends of the inter-element wiring parts 24a and 24b are respectively connected, and electrodes 28 to which ends of the return wiring parts 25a and 25b are respectively connected. The electrodes 27 and 28 of these pairs are arranged side by side in the longitudinal direction of the substrate 20. The electrodes 27 and 28 are formed of pads of wiring patterns. In this embodiment, the electrode 27 is arranged to be closer to the end side of the substrate 20 than the electrode 28. However, the electrode 28 may be arranged to be closer to the end side of the substrate 20 than the electrode 27, or the arrangement of the electrode 27 and the electrode 28 may change between one end side of the substrate 20 and the other end side.

In the respective inter-module connection parts 26a and 26b of the light-emitting modules 11 connected to each other, the corresponding electrodes 27 and the electrodes 28 are respectively electrically connected by a connection unit 29. As the connection unit 29, for example, a covered electric wire in which a conductive wire is covered with insulation is used. Both ends of the covered electric wire are connected to the electrodes 27 and 28 by soldering or welding. Incidentally, as the connection unit 29, a connector connected to the electrodes 27 and 28 and mounted on the substrate 20 may be used.

As shown in FIG. 3, the support body 12 is made of a material such as aluminum and formed in a longitudinal shape. A back surface on the opposite side to the mount surface of the substrate 20 of the light-emitting module 11 contacts the support body and is fixed by screwing or the like.

The cover 13 has translucency in at least a light irradiation direction, and has a light diffusion property so that color mixture of lights of plural color temperatures becomes excellent.

The caps 14 at both ends are, for example, GX16t-5 caps. A pair of L-shaped lamp pins 32 protrudes from an end face. Incidentally, the caps 14 at both ends may be existing fluorescent lamp caps such as G13 caps. The lamp pins 32 of the cap 14 are used for attachment to a luminaire 40. However, the lamp pins are not used for electrical connection and are insulated from the light-emitting module 11.

A first power receiving connector 33a and a second power receiving connector 33b as power receiving connectors are provided at the caps 14 at both ends or both ends of the cover 13 and on the opposite side to the light irradiation direction from the cover 13. The power receiving connectors 33a and 33b are of a two-pin type, and the +side and −side of DC power are distinguished. The power receiving connectors are constructed so that connector connection is possible only when the polarities are matched.

FIG. 2 is a wiring view of the straight tube lamp 10. The first light-emitting circuits 21a of the plural light-emitting modules 11 are respectively sequentially connected by the connection units 29. The first power receiving connector 33a is connected to the electrodes 27 and 28 on one end side of the first light-emitting circuits 21a. The electrodes 27 and 28 on the other end side are short-circuited by a short-circuit unit 34 such as, for example, a covered electric wire or a connector. The first light-emitting circuits 21a constitute a flat circuit with respect to the first power receiving connector 33a. Similarly, the second light-emitting circuits 21b of the plural light-emitting modules 11 are respectively sequentially connected by the connection units 29. The second power receiving connector 33b is connected to the electrodes 27 and 28 on the other end side of the second light-emitting circuits 21b. The electrodes 27 and 28 on one end side are short-circuited by the short-circuit unit 34. The second light-emitting circuits 21b constitute a flat circuit with respect to the second power receiving connector 33b.

Incidentally, a rectifier may be used for circuit protection in a DC power input part of the straight tube lamp 10. However, if the polarities of the +side and the −side of DC power inputted to the straight tube lamp 10 can be certainly distinguished by the connector connection, the rectifier may not be used.

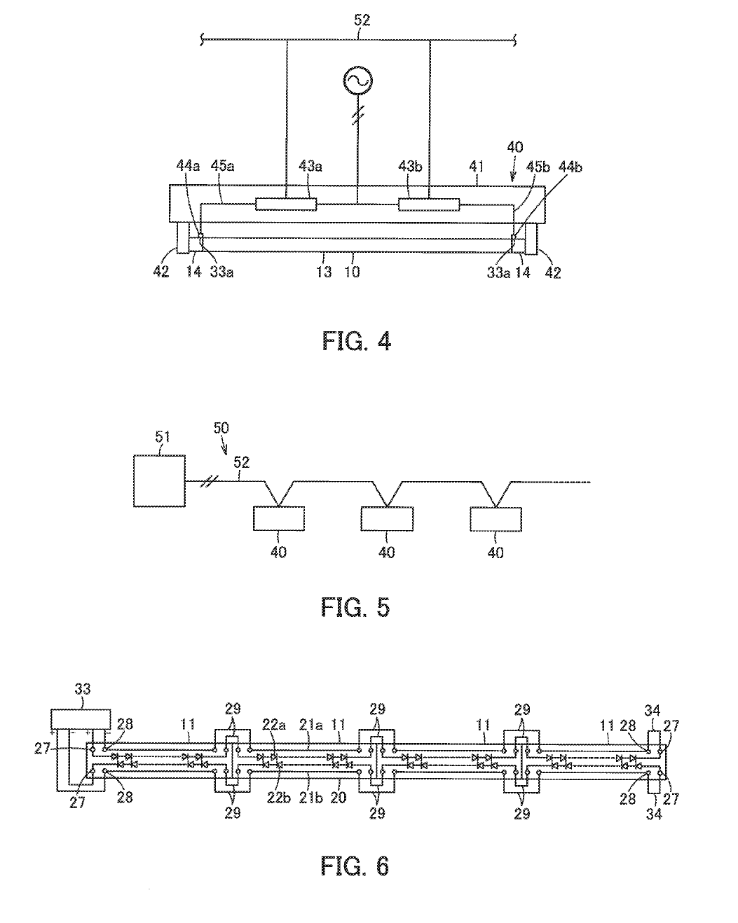

FIG. 4 shows the luminaire 40 using the straight tube lamp 10. The luminaire 40 includes a longitudinal luminaire main body 41 installed on a ceiling or the like, a pair of sockets 42 attached to both ends of the luminaire main body 41 in the longitudinal direction and facing each other, a first power supply device 43a and a second power supply device 43b as power supply devices installed in the luminaire main body 41.

The power supply device 43a, 43b converts inputted AC power into specified DC power to dim and light the light-emitting element 22a, 22b of the light-emitting circuit 21a, 21b and outputs the DC power. A first feeding cable 45a having an end provided with a first feeding connector 44a as a feeding connector is connected to an output part of the first power supply device 43a. The first feeding cable 45a is pulled out to the outside from one end side of the luminaire main body 41. A second feeding cable 45b having an end provided with a second feeding connector 44b as a feeding connector is connected to an output part of the second power supply device 43b. The second feeding cable 45b is pulled out to the outside from the other end side of the luminaire main body 41. The feeding connectors 44a and 44b are of a two-pin type, and the +side and −side of DC power are distinguished. The feeding connectors 44a and 44b can be connected to the power receiving connectors 33a and 33b of the straight tube lamp 10 mounted to the sockets 42 only when the polarities are matched. Accordingly, the first power supply device 43a is connected to the first light-emitting circuits 21a and power can be supplied. The second power supply device 43b is connected to the second light-emitting circuits 21b and power can be supplied.

Each of the power supply devices 43a and 43b has an intrinsic address, and receives a control signal transmitted from the outside by a signal line or power line communication system and including a dimming signal corresponding to its own address. The power supply device controls conversion into the DC power according to the received control signal, and dims and lights the light-emitting element 22a, 22b of the light-emitting circuit 21a, 21b.

When the straight tube lamp 10 is mounted to the luminaire 40, the caps 14 of the straight tube lamp 10 are mounted and attached to the sockets 42. Then, the feeding connectors 44a and 44b at the ends of the feeding cables 45a and 45b pulled out from the luminaire main body 41 are connected to the power receiving connectors 33a and 33b of the straight tube lamp 10.

FIG. 5 shows a lighting control system 50 using plural luminaires 40. In the lighting control system 50, for example, in a facility such as an office or a store, the plural luminaires 40 installed in the facility are divided into some groups, and the luminaires 40 in each of the groups are collectively controlled, monitored and managed.

The lighting control system 50 includes a main control device 51, and power supply devices 43a and 43b of the plural luminaires 40 are connected to the main control device 51 by, for example, a signal line 52 or power line communication system to be capable of communicating. The main control device 51 transmits control signals correlated to addresses of the power supply devices 43a and 43b of the luminaire 40 to be controlled.

The first power supply device 43a supplies DC power to the first light-emitting circuit 21a of the straight tube lamp 10, so that the plural first light-emitting elements 22a connected in series to the first light-emitting circuit 21a are lit. The light of the first color temperature generated by the first light-emitting elements 22a passes through the cover 13 and is emitted to the lighting space. Besides, the second power supply device 43b supplies DC power to the second light-emitting circuit 21b of the straight tube lamp 10, so that the plural second light-emitting elements 22b connected in series to the second light-emitting circuit 21b are lit. The light of the second color temperature generated by the second light-emitting elements 22b passes through the cover 13 and is emitted to the lighting space.

In the state where both the first light-emitting elements 22a and the second light-emitting elements 22b are lit, the light of the first color temperature generated by the first light-emitting elements 22a and the light of the second color temperature generated by the second light-emitting elements 22b are mixed, and the thus obtained light passes through the cover 13 and is emitted to the lighting space. At this time, in the plural light-emitting modules 11 arranged linearly, the first light-emitting elements 22a and the second light-emitting elements 22b are linearly alternately arranged one by one at a constant inter-element pitch in the longitudinal direction of the substrate 20 and in the center area of the substrate 20 in the short direction. Thus, color mixing of the light of the first color temperature and the light of the second color temperature is excellently performed. Further, since the cover 13 has the sufficient light diffusion property, the color mixing is more excellently performed.

Besides, in the lighting control system 50, the main control device 51 dims and controls the light-emitting elements 22a and 22b of the straight tube lamp 10 mounted to the luminaire 40. The main control device 51 transmits the control signals correlated to the addresses of the power supply devices 43a and 43b of the luminaire 40. The power supply devices 43a and 43b of the luminaire 40 receive the control signals having their own address, control the conversion into DC power according to the received control signals, and dim the light of the light-emitting elements 22a and 22b of the light-emitting circuits 21a and 21b. That is, the first power supply device 43a changes the DC power supplied to the first light-emitting circuit 21a, and the light output of the first light-emitting elements 22a is changed. The second power supply device 43b changes the DC power supplied to the second light-emitting circuit 21b, and the light output of the second light-emitting elements 22b is changed.

For example, the light flux from the straight tube lamp 10 is made constant, and the dimming ratio of the first light-emitting element 22a and the second light-emitting element 22b is changed. In this case, for example, the light output from the first light-emitting element 22a is made high, and the light output from the second light-emitting element 22b is made low. As a result, the color temperature of the straight tube lamp 10 can be changed to the color temperature including more light of the first color temperature. On the other hand, the light output from the first light-emitting element 22a is made low, and the light output from the second light-emitting element 22b is made high. As a result, the color temperature of the straight tube lamp 10 can be changed to the color temperature including more light of the second color temperature.

Alternatively, the dimming ratio of the first light-emitting element 22a and the second light-emitting element 22b of the straight tube lamp 10 is changed. In this case, for example, the light output from the second light-emitting element 22b is changed while the light output from the first light-emitting element 22a is constant. Alternatively, the light output from the first light-emitting element 22a is changed while the light output from the second light-emitting element 22b is constant. As a result, the color temperature of the straight tube lamp 10 can be changed to include more light of the first color temperature or more light of the second color temperature. Further, the light output of the combined light can also be changed.

As described above, the color temperature of the light emitted from the one straight tube lamp 10 can be easily changed.

The light-emitting module 11 includes the two light-emitting circuits 21a and 21b. The inter-module connection parts 26a and 26b are formed such that the respective pairs of electrodes 27 and 28 connected with the respective light-emitting circuits 21a and 21b are arranged to be closer to the side parts of the substrate 20 in the short direction than the arrangement area of the light-emitting elements 22a and 22b and are arranged side by side in the longitudinal direction of the substrate 20. Thus, when the plural light-emitting modules 11 are linearly arranged and are connected, the respective light-emitting circuits 21a and 21b between the light-emitting modules 11 can be connected by using the inter-module connection parts 26a and 26b. Further, since the arrangement of the light-emitting elements 22a and 22b toward the end side of the substrate 20 is not restricted by the electrodes 27 and 28, the light-emitting elements 22a and 22b can be arranged at the constant inter-element pitch between the light-emitting modifies 11. Accordingly, a dark part does not occur between the light-emitting modifies 11, and a uniform light-emitting distribution can be obtained between the light-emitting modifies 11.

Further, since the electrodes 27 and 28 are arranged side by side in the longitudinal direction of the substrate 20, the width size of the substrate 20 in the short direction can be reduced.

In the straight tube lamp 10 using the light-emitting modules 11, the uniform light-emitting distribution can be obtained in the tube axial direction of the cover 13. Even when the color temperature of the light-emitting color of the straight tube lamp 10 is changed, the uniform color temperature distribution can be obtained in the tube axial direction of the cover 13.

Since the straight tube lamp 10 and the power supply devices 43a and 43b are connected through the connector, the +side and −side polarities of DC power are certainly distinguished, and power can be supplied to the straight tube lamp 10.

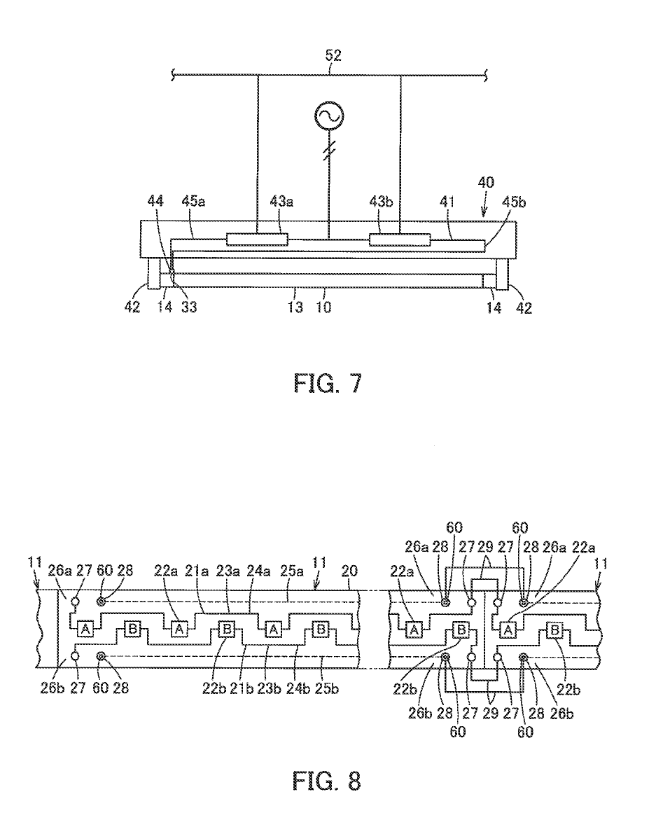

FIG. 6 and FIG. 7 show a second embodiment. Incidentally, with respect to the same components and effects as those of the first embodiment, the same reference numerals are used and the description thereof will be omitted.

A straight tube lamp 10 includes one power receiving connector 33 only on one end side. The power receiving connector 33 is of a four-pin type, and the +side and −side of DC power of two systems are respectively distinguished. The connector connection can be performed only when the polarities of the systems are matched.

FIG. 6 is a wiring view of the straight tube lamp 10. First light-emitting circuits 21a of plural light-emitting modules 11 are respectively sequentially connected by connection units 29. The power receiving connector 33 is connected to electrodes 27 and 28 on one end side of the first light-emitting circuit 21a. Electrodes 27 and 28 on the other end side are short-circuited by a short-circuit unit 34. The first light-emitting circuits 21a constitute a flat circuit with respect to the power receiving connector 33. Similarly, second light-emitting circuits 21b of the plural light-emitting modules 11 are respectively sequentially connected by connection units 29. The power receiving connector 33 is connected to electrodes 27 and 28 on one end side of the second light-emitting circuit 21b. Electrodes 27 and 28 on the other end side are short-circuited by a short-circuit unit 34. The second light-emitting circuits 21b constitute a flat circuit with respect to the power receiving connector 33.

As shown in FIG. 7, feeding cables 45a and 45b connected to output parts of power supply devices 43a and 43b are connected to one feeding cable 44. The feeding cable 44 is of a four-pin type, and the +side and −side of DC power of two systems are respectively distinguished. The feeding connector can be connected to the power receiving connector 33 of the straight tube lamp 10 mounted to sockets 42 only when the polarities of the systems are matched. Accordingly, the first power supply device 43a is connected to the first light-emitting circuits 21a and power can be supplied. The second power supply device 43b is connected to the second light-emitting circuits 21b and power can be supplied.

FIG. 8 shows a third embodiment. Incidentally, with respect to the same components and effects as those of the foregoing respective embodiments, the same reference numerals are used and the description thereof will be omitted.

A two-sided mount substrate is used as a substrate 20. Through holes 60 are formed in the substrate 20 correspondingly to positions of respective electrodes 28 to which return wiring parts 25a and 25b are connected. The return wiring parts 25a and 25b to connect between the through holes 60 are formed on a back surface side of the substrate 20.

By the structure as stated above, even when two or three or more light-emitting circuits are disposed on the substrate 20, the light-emitting circuits can be disposed while the insulation therebetween is secured.

In this case, an insulation sheet is disposed on the back surface side of the substrate 20 and is attached to a metal support body 12, so that the insulation is secured.

Incidentally, the number of the light-emitting circuits formed on the substrate is not limited to two, and may be three or more. Also in this case, electrodes of the respective light-emitting circuits have only to be arranged side by side in the longitudinal direction of the substrate.

Besides, the respective light-emitting circuits are not limited to the case of different color temperatures, and may have the same color temperature.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light-emitting module comprising:
a rectangular substrate;
at least two light-emitting circuits to connect a plurality of light-emitting elements arranged in a longitudinal direction of the substrate; and
inter-module connection parts which include respective pairs of electrodes connected with the respective light-emitting circuits on an end side of the substrate in the longitudinal direction, wherein the respective pairs of electrodes are arranged to be closer to side parts of the substrate in a short direction than an arrangement area of the light-emitting elements and are arranged side by side in the longitudinal direction of the substrate.

2. The module according to claim 1, wherein each of the light-emitting circuits includes an element wiring part to connect the plurality of light-emitting elements in series in the longitudinal direction of the substrate, and a return wiring part in the longitudinal direction of the substrate, and an end of the element wiring part and an end of the return wiring part are connected to the pair of electrodes.

3. The module according to claim 1, wherein the light-emitting elements of the respective light-emitting circuits are alternately arranged by every specified number of light-emitting elements in the longitudinal direction of the substrate.

4. The module according to claim 1, wherein the light-emitting elements of the respective light-emitting circuits are arranged in a center of the substrate in the short direction and alternately arranged one by one in the longitudinal direction of the substrate.

5. The module according to claim 1, wherein a distance between the light-emitting element positioned at an end of the substrate and the end of the substrate is ½ of a pitch of the light-emitting elements.

6. The module according to claim 1, wherein the respective light-emitting circuits are separately provided on one side of the substrate in the short direction and on the other side.

7. The module according to claim 1, wherein color temperatures of the light-emitting elements are different in the respective light-emitting circuits.

8. The module according to claim 1, wherein color temperatures of the light-emitting elements of the respective light-emitting circuits are identical.

9. A straight tube lamp comprising:
a plurality of light-emitting modules which are linearly arranged in a longitudinal direction and each of which includes a rectangular substrate, at least two light-emitting circuits to connect a plurality of light-emitting elements arranged in the longitudinal direction of the substrate, and inter-module connection parts which include respective pairs of electrodes connected with the respective light-emitting circuits on an end side of the substrate in the longitudinal direction, wherein the respective pairs of electrodes are arranged to be closer to side parts of the substrate in a short direction than an arrangement area of the light-emitting elements and are arranged side by side in the longitudinal direction of the substrate;
a connection unit to connect the inter-module connection parts of the adjacent light-emitting modules;
a straight tube cover to contain the light-emitting modules; and
caps provided on both ends of the cover.

10. The lamp according to claim 9, wherein each of the light-emitting circuits includes an element wiring part to connect the plurality of light-emitting elements in series in the longitudinal direction of the substrate, and a return wiring part in the longitudinal direction of the substrate, and an end of the element wiring part and an end of the return wiring part are connected to the pair of electrodes.

11. The lamp according to claim 9, wherein the light-emitting elements of the respective light-emitting circuits are alternately arranged by every specified number of light-emitting elements in the longitudinal direction of the substrate.

12. The lamp according to claim 9, wherein the light-emitting elements of the respective light-emitting circuits are arranged in a center of the substrate in the short direction and alternately arranged one by one in the longitudinal direction of the substrate.

13. The lamp according to claim 9, wherein a distance between the light-emitting element positioned at an end of the substrate and the end of the substrate is ½ of a pitch of the light-emitting elements.

14. The lamp according to claim 9, wherein the respective light-emitting circuits are separately provided on one side of the substrate in the short direction and on the other side.

15. The lamp according to claim 9, wherein color temperatures of the light-emitting elements are different in the respective light-emitting circuits.

16. The lamp according to claim 9, wherein color temperatures of the light-emitting elements of the respective light-emitting circuits are identical.

17. The lamp according to claim 9, further comprising a power receiving connector connected to the light-emitting circuit of the light-emitting module.

18. A luminaire comprising:
a straight tube lamp according to claim 17;
a pair of sockets to which the respective caps at both ends of the straight tube lamp are mounted;
a feeding connector connected to the power receiving connector of the straight tube lamp; and
power supply devices to supply power to the respective light-emitting circuits through the feeding connector.
